(19) United States
(12) Patent Application Publication
(10) Pub. No.: US 2011/0276883 A1
(43) Pub. Date: Nov. 10, 2011

(54) Online Multiplayer Virtual Game and Virtual Social Environment Interaction Using Integrated Mobile Services Technologies

(76) Inventors: Mark Cabble, Fort Mohave, AZ (US); Philippe Van Hecke, Allen, TX (US); Guy Stables, Richardson, TX (US)

(21) Appl. No.: 13/102,689

(22) Filed: May 6, 2011

Related U.S. Application Data
(60) Provisional application No. 61/332,394, filed on May 7, 2010.

(51) Int. Cl. G06F 15/16; G06F 3/16

(52) U.S. Cl. 715/727; 709/206

(57) ABSTRACT

A system, method, and software allowing user interaction with virtual games/virtual social environments by using a mobile device and SMS/MMS messaging over a cellular telephone network. A communication device server sends to and accepts from a mobile aggregator, asynchronous SMS/MMS/text/email messages related to a virtual game running on a game server. The virtual game server integrates with a virtual social network utility such as Facebook®, and is accessible to the user through a dedicated web server. Multiple users may register with the social network utility to access the virtual game over the computer network (using the social network utility web server or a dedicated web server) or over the cellular telephone network (using the aggregator/communication device server). This system and method allows the user to interact with the virtual game/virtual social network while the user is offline.

### CROSS-REFERENCE TO RELATED APPLICATIONS

This application claims the benefit of provisional Application No. 61/332,394, filed May 7, 2010.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to online virtual games and virtual social environments and, more specifically, to a system and method for using mobile devices to interact with online virtual games and virtual social environments.

2. Description of Related Art including information disclosed under 37 CFR 1.97 and 1.98

In the 1990's the expansion and use of mobile phones created a new market that has blossomed over the years. In the early 2000's mobile phone and mobile phone entertainment companies started offering mobile SMS (Short Message Service) and mobile MMS (Multimedia Messaging Service) services for entertainment and information purposes. Utilizing these services, users were able to send rich messages and receive alerts of all types (such as sports, horoscopes, advertisements, etc.) on their mobile devices.

During the same period online virtual games/virtual social environments were developed and quickly ascended in popularity. Virtual games have become more and more popular, being played on computers and laptops.

There is currently no link between the two industries where a user can enjoy an online virtual game/virtual social environment while interacting through SMS and MMS entertainment, services of value to the end users in their daily lives, and services of use to play the online virtual game/virtual social environment.

There is a need for a platform the integrates both technologies, wherein a user can enjoy both an online virtual game/virtual social environment while interacting through mobile service offerings while also having the capability of participating in the game, all while utilizing his or her mobile computing device.

### BRIEF SUMMARY OF THE INVENTION

Disclosed herein is a system for allowing an offline user to interact with an online virtual game/virtual social network, the system comprising: at least one computing device configured to perform the processing steps comprising: accepting an event message generated by an online virtual game server or online virtual social environment; relaying at least a portion of the event message to the communication device of an offline first user; accepting an event response message from the offline first user, wherein the event response message is in response to the event message and contains a command to the online virtual game or online virtual social environment; and relaying the event response message to the virtual game or virtual social environment for subsequent action therein.

Also disclosed herein is a method implemented on a first computing device configured for allowing an offline user to interact with an online virtual game/virtual social network, the method steps comprising: accepting an event message generated by an online virtual game server or online virtual social environment; relaying at least a portion of the event message to the communication device of an offline first user; accepting an event response message from the offline first user, wherein the event response message is in response to the event message and contains a command to the online virtual game or online virtual social environment; and relaying the event response message to the virtual game or virtual social environment for subsequent action therein.

The present invention advantageously fills the aforementioned deficiencies by changing how users interact with online virtual game/virtual social environments largely through a connection with mobile device messaging technology (SMS and MMS). User interaction with the game is allowed without requiring the user to be online.

Currently online virtual game/virtual social environments do not feature SMS and MMS interaction and do not offer social networking capabilities through mobile communications devices. An online virtual game/virtual social environment is created, and is highly integrated and scalable to allow users to play a game through unique SMS and MMS features and interact with each other.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a block diagram of an embodiment of the invention, depicting the interrelationship of the components of the system; and

FIG. 2 is a flow diagram depicting the process steps taken by an embodiment of the system.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

As used herein, the term “interaction” means: (i) some, part or the whole of the online virtual game/virtual social environment takes place using SMS and/or MMS technology through short code or long code via the mobile network, (ii) through the online virtual game/virtual social environment architecture and features, SMS and MMS technology allows users to receive commercial offerings, (iii) through the online virtual game/virtual social environment architecture and features, users connect with one another through SMS, MMS, or text messaging on mobile devices, or (iv) through the online virtual game/virtual social environment and features users will receive informational and entertainment content in either SMS or MMS format in premium (for a fee) or non-premium (free) delivery.

The term “online user” means that the user is directly logged-into a virtual game/virtual social environment service over a wired or wireless computer network. Conversely, the term “offline user” means that the user is no longer directly logged-into the virtual game/virtual social environment service. The terms “online virtual game” and “online virtual social environment” mean that the virtual game and virtual social environment, respectively, are connected to a computer network and are capable of being accessed by a user.

The system servers of the present invention can be implemented on one or more networked computing platforms, one or more of which are locally or remotely accessible by a user. For example, the computing platform can be a stored program computer such as a desktop, laptop, server, mainframe, or the like, including but not limited to a RISC or CISC processor, a DSP, a programmable logic device or the like, capable of executing stored program instructions. Further, it is possible that the system may utilize any one or some combination of the aforementioned devices. Choice of hardware and implementation is considered to be within the skill of one of ordinary skill in the art for which the invention applies.

The various process steps of the present invention can be implemented in high or low level programming or scripting languages, such as Basic, C, C++, C#, .NET, Jscript, Java, PHP, SQL, XML, XFBML, CSS, Flash, or the like, or some combination thereof. While certain programming languages are necessitated by the environments in which online virtual gaming is provided (for example, XFBML is an extensible markup language utilized by the Facebook® social networking platform), choice of programming language and implementation of the novel method steps is considered to be within the skill of one of ordinary skill in the art for which the invention applies.

As used herein “computer readable medium” means any tangible portable or fixed RAM or ROM device, such as portable flash memory, a CDROM, a DVDROM, embedded RAM or ROM integrated circuit devices, or the like.

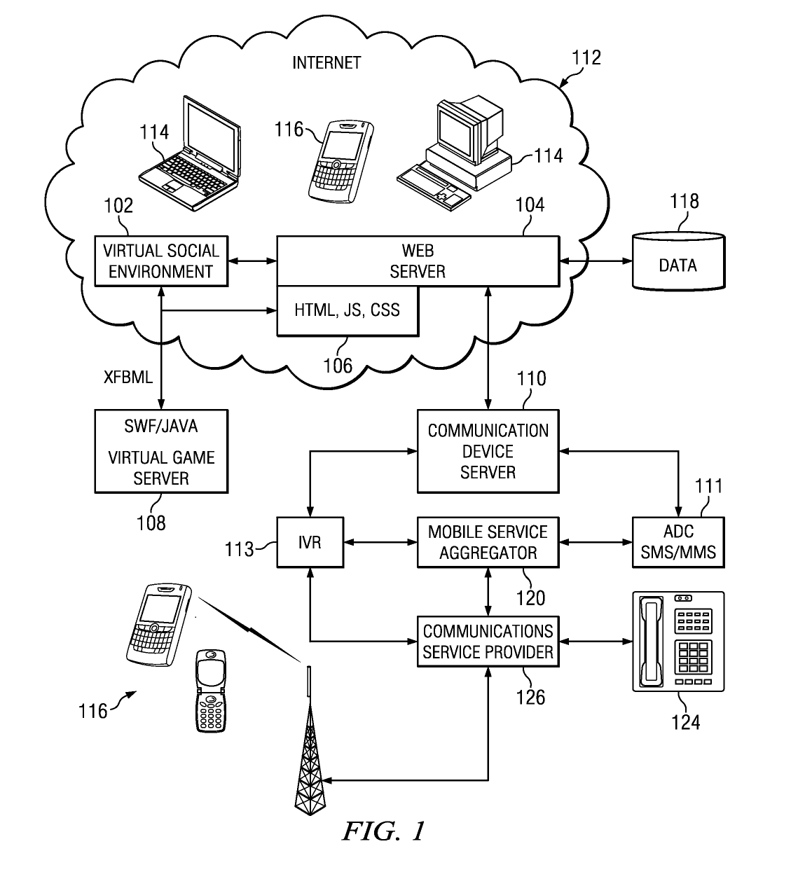

FIG. 1 provides a block diagram of an embodiment of the invention, depicting the interrelationship of various components of the system. In this embodiment, a web server (104) delivers web and virtual game files (SWF) to the user that interfaces with a virtual social networking site (102), such as Facebook® or MySpace®, through the social network's API. As depicted, the virtual social network (102) is Facebook®. The virtual game server (108) utilizes XFBML to communicate between the game server and the Facebook® server (102) for presentation to a user. Although Facebook® is primarily discussed herein, one of ordinary skill will appreciate that it is possible to utilize any online social networking website that allows hosting of virtual social game platforms.

The virtual game server (108) in this embodiment hosts an online virtual game/virtual social environment backend that is written using a fast middleware solution such as Java or Blaze DS. The game in this embodiment is developed using the Flash or Flex programming language and written in ActionScript because this programming language is relatively platform independent and allows a single game to run on multiple client side platforms (i.e., PC, Mac, UNIX, Flash enabled phone, etc.). Nonetheless, one of ordinary skill in the art will appreciate that it is also possible to provide games written in other programming languages that may or may not provide platform independence. Ultimately, choice of programming language for the online virtual game/virtual social environment running on the game server (108) and client's machine is inconsequential and all such game development languages are intended to be included herein and are within the scope of the present invention.

A web server (104) is depicted along with a module that provides HTML/JavaScript/CSS encapsulation (106) and game files (108). By encapsulating the game file within HTML and JavaScript, the game file may be displayed and accessed by a user within a Web browser. The user may initiate this access on a networked computer (114), smart phone, or other mobile computing device (116) (including mobile phone, smart phone, iPad, laptop, tablet PC, or other such wireless communication device) over the Internet (112) or any other wireless or computer network by either registering with the social network (102) or by accessing the game server web server (104). This interface may occur over a wired or wireless packetized-network connection, and may be a MAN, WAN, LAN, PAN or the like, or some combination thereof.

A communication device server (110) is provided to allow game interaction and asynchronous messaging to occur over the wireless telephone networks directly with mobile communications devices (116). The communication device server (110) accepts packetized online virtual game/virtual social environment interaction-request event messages from the web server (104). The event message may be synchronous or asynchronous. The communication device server (110) also receives configuration data from the user's configuration profile from the Web server (104). The configuration data is utilized by the communication device server to determine how to communicate the message to the user (such as by SMS, MMS, text, message or the like). The event message data, or a portion of the message data, is formatted by the communication device server, which then submits the formatted message to a mobile service aggregator (120), which processes the event message data for broadcast to one or more users' smart phone or other mobile communication device (116) or other preferred means of communication, based at least in part upon the user's profile data.

The aggregator service (120) provides a single interface to the myriad of mobile network provider carriers (e.g., Sprint, Verizon, AT&T, etc.). In addition to the messages being passed to the user's mobile device (116), the aggregator also accepts SMS, MMS, text, email messages, or the like (111) from the mobile device user (116) as responsive commands to the online virtual game/virtual social environment or for delivery to another user. The aggregator (120) relays the SMS/MMS/text event response message command to the communication device server (110), which packetizes and forwards the event response message command data to the virtual game server (108) and/or virtual social environment (102) via the Web server (104). Users may also communicate with the system with voice commands through an Interactive Voice Response (IVR) technology device (113). This IVR device converts the user's speech to text that may be processed directly by the communication device server (110) or the aggregator (120) where it may be passed to another user as an SMS/MMS/text message. Communication is, thus, bi-directional among the game server (108), virtual social environment (102), Web server (104), and the users (116). A user may access the system using either a wireless mobile device (116) or a landline phone (124) operating through a communications service provider (126).

Although individual servers are discussed herein for the various system devices, one of ordinary skill in the art will appreciate and understand that a single server platform may be utilized with virtual servers running thereon, or multiple servers may be utilized for load balancing or even redundancy.

As users advance within the game, they typically achieve points, make purchases, updates or modifications to their virtual environments, or make other advances within the online virtual game/virtual social environment. A database server (118) persists a user's game advances to allow intermittent play without losing his or her position within the online virtual game/virtual social environment. This database provides a means for storing not only online virtual game/virtual social environment related data, but data associated with the user's desired configuration and connections with other users. This database may use SQL or similar data storage technologies.

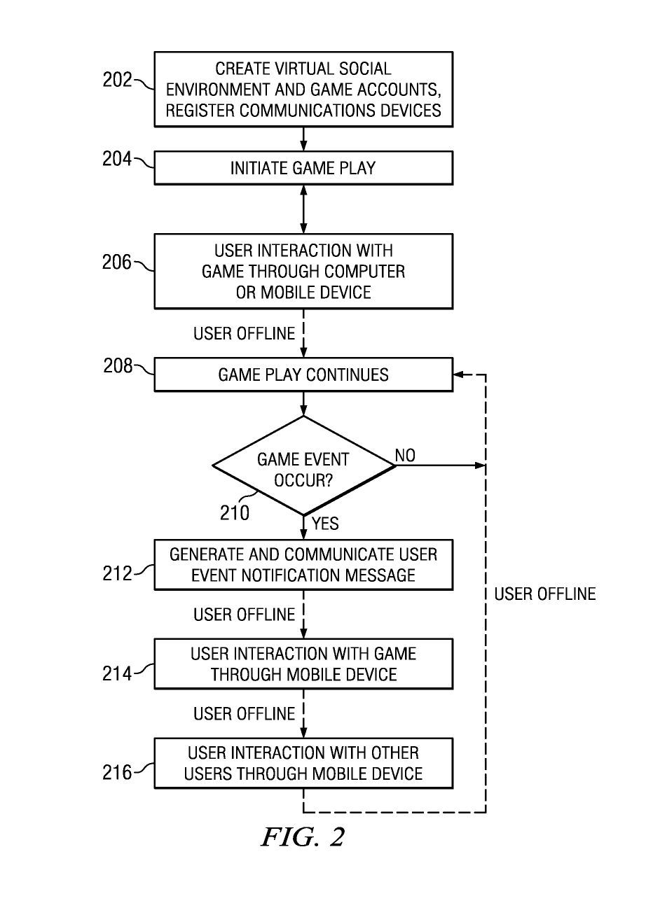

FIG. 2 depicts a flow diagram presenting the main process steps taken by the present embodiment. As depicted, the user first creates a virtual social environment account (202), enabling him or her to access the virtual social environment offered therein. During account creation, the user registers his or her communications preferences with the account provider. For example, the user may provide information such as, but not limited to: the phone number for each of the mobile communication devices that may access the system; the capabilities of each registered communication device (for example, whether the device has text, SMS, and/or MMS communications capabilities); the phone number for any landline communication device that may receive event notifications (including capabilities of the landline); the user's email accounts; etc.

Once registered, the user may initiate game play (204). Game play in the present embodiment is initiated while the user is online and logged into the virtual social environment service. User interaction with the game may then be conducted using his or her desktop computer or mobile communication device (206). Because virtual games in virtual social environments may have a multitude of concurrent users, the game play may continue even after the user logs-off of the service and goes offline (208).

As the virtual game play continues while the user is offline, events may still occur (210). For example, the user may have a home in his or her virtual game that “catches on fire.” Since the user is offline, this embodiment of the system generates a notification message to inform the user as such (212). Notification messages include use of SMS, MMS, or text messaging, IVR technology, text to speech, or the like. The communication device server accesses the user's account to determine the preferred method of communicating events to the user. For example, if the user's mobile device accepts SMS, MMS, or text messages, the appropriately formatted message is generated (e.g., “Your house is on fire! Please send [KEYWORD] to [SHORT CODE or LONG CODE] to extinguish fire now!”). The use of short code or long code may be determined by the tier of service (premium or non-premium). If the communication preference is for text to speech, or if the communication device happens to be a landline phone with voice-only capabilities, the event message is read aloud to the user upon answering the call. The user then, through touch tone or voice recognition, reacts to the event message.

Upon receiving the event message inviting the user to respond to the event, the user may then interact with the virtual game/virtual social environment through his or her mobile device while remaining offline (214). If the event notification involves other user(s), the first user (recipient) can interact with the other user(s) as with the virtual game/virtual social environment (216). The communication device server accepts several modes of interaction, including SMS, MMS, and text messaging, IVR, and touch-tone.

With SMS, MMS, and text messaging the user may respond to the event notification by typing a response message containing instructions, and sending the message to the communication device server. The communication device server processes the message and executes the user's commands with regard to his or her virtual game/virtual social environment, or with regard to another user who may be involved somehow with the event that is part of the event notification.

Users can interact with the virtual game/virtual social environment and/or with each other through IVR (Interactive Voice Response) technology either via voice recognition and/or touchtone interaction. For example, a user can access the IVR platform by calling from a regular land line or mobile device and speaking commands for virtual game/virtual social environment interaction. Users will be able to reach the service by dialing a toll free number, a local number or, in the case of mobile device, an Abbreviated Dial Code (ADC) number. Once connected, users have the opportunity to (a) listen to content related to their virtual game/virtual social environment; (b) interact and respond to events within their virtual game/virtual social environment; and/or (c) connect with other users. This interaction can be voice activated, or a combination of voice recognition and SMS technology. For example, the landline user may speak commands to the IVR platform to directly interact with the virtual game/virtual social environment to address an event notification. If the event notification happens to involve another user as well, the landline user may interact with the other user through the IVR platform by converting the spoken instructions to text, which is then forwarded to the other user's mobile device as an SMS, MMS, or text message. If the other user is on a landline as well, the IVR platform can either forward the spoken audio, or convert the text back to speech.

Example Situation 1: SMS/MMS play: users enter the online virtual game/virtual social environment through their computer or other online browser enabled mobile devices. Users sign up to enter the virtual world.

As users interact in the online virtual game/virtual social environment, they fulfill specific tasks through API registration or via short or long code registration directly from their mobile computing devices. Users progress through the online virtual game/virtual social environment by interacting with the online virtual game/virtual social environment through their mobile devices using either the computer network or the mobile network (i.e., SMS/MMS message communications, IVR, touch tone, ADC).

Example Situation 2: Interaction through SMS/MMS play: users enter the online virtual game/virtual social environment through their computer or other browser equipped mobile devices. Users sign up to enter the virtual world. As users interact in the online virtual game/virtual social environment, they are prompted to enter their cell phone numbers to receive mobile offerings: mobile discounts, mobile couponing, mobile giveaway, mobile promotion and special offers. This interactivity also allows users to gain certain privileges in the online virtual game/virtual social environment in which they are participating, and allow for data collection on behalf of the online game provider.

Example Situation 3: Interaction through SMS/MMS play: users enter the online virtual game/virtual social environment through their computer or other online browser equipped mobile devices. Users sign up to enter the virtual world. As players interact in the virtual world, they are prompted to enter their cell phone numbers to exchange SMS/MMS messages with each other as well as to connect and to socially network.

Example Situation 4: Interaction through SMS/MMS/text/IVR/touch-tone play: users enter the online virtual game/virtual social environment through their computer or other online browser equipped mobile devices. Users sign up to enter the online virtual game/virtual social environment. As users interact in the virtual world, they are prompted to enter their cell phone numbers to receive content specific to their requests. Content can be delivered via the communication device server over the mobile telephone network in SMS, MMS, or text message format, IVR or touch-tone.

Some SMS/MMS messages will alert a user to random issues involving the online virtual game/virtual social environment. For example, an event such as a fire in the online virtual game/virtual social environment may trigger an SMS message indicating that the user's “building is on fire” with a request to the user to address the issue via their mobile device in a timely manner. A sponsor, advertiser's name or offer can also be included in the SMS/MMS message. Other messages might also be communicated between one or more users, possibly in the form of an SMS/MMS “community blast,” inviting them to interact in each other's virtual environment. This specific SMS/MMS service could also be a place for a sponsor or advertiser's message, allowing the user that sent out the invitation to enhance their standing. Global events, such as vote campaigns or sweepstakes, might be asynchronously communicated to a community of users via SMS/MMS requests where all will be invited to participate. For example, an ongoing election for the mayor of a virtual world can allow a user to have his or her “15 minutes of frame” on the virtual world's home page. Such a message is valuable to a sponsor or advertiser due to the mass distribution of the message. Another example of messages between users is where one invites another to their store to visit. The store owner might choose to offer a sponsor discount to the guest user over the guest's mobile device. Both users might also receive additional game play credits to enhance each player's standing in the online virtual game/virtual social environment.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. A system for allowing an offline user to interact with an online virtual game/virtual social network, the system comprising:
at least one computing device configured to perform the processing steps comprising:
accepting an event message generated by an online virtual game server or online virtual social environment;
relaying at least a portion of the event message to the communication device of an offline first user;
accepting an event response message from the offline first user, wherein the event response message is in response to the event message and contains a command to the online virtual game or online virtual social environment; and
relaying the event response message to the virtual game or virtual social environment for subsequent action therein.

2. The system of claim 1, wherein the event message is asynchronous.

3. The system of claim 1, wherein the communication device is a wireless mobile device or a landline device.

4. The system of claim 1, wherein at least a portion of the event message includes promotional offerings for the offline first user.

5. The system of claim 1, wherein at least a portion of the event message is relayed as an audible message to the offline first user.

6. The system of claim 1, the at least one computing device processing steps further comprising:
relaying at least a portion of the event message to the communication devices of a plurality of offline user's; and
accepting an event response message from at least one of the plurality of offline users.

7. The system of claim 1, the system further comprising:
an Interactive Voice Response (IVR) device, wherein the IVR device accepts a spoken event response message from the offline first user.

8. The system of claim 1, the system further comprising:
an Interactive Voice Response (IVR) device, wherein the IVR device accepts a spoken event response message from the offline first user, and wherein the event message contains interaction instructions intended for at least one offline second user; and
the at least one computing device processing steps further comprising:
relaying at least a portion of the spoken event response message to the offline second user.

9. The system of claim 1, the system further comprising:
an Interactive Voice Response (IVR) device, wherein the IVR device accepts a spoken event response message from the offline first user, and wherein the event message contains interaction instructions intended for at least one offline second user; and
the at least one computing device processing steps further comprising:
relaying at least a portion of the spoken event response message to the offline second user, wherein the portion of the spoken event message is relayed as an SMS, MMS, text, or email message to the offline second user.

10. A method implemented on a first computing device configured for allowing an offline user to interact with an online virtual game/virtual social network, the method steps comprising:
accepting an event message generated by an online virtual game server or online virtual social environment;
relaying at least a portion of the event message to the communication device of an offline first user;
accepting an event response message from the offline first user, wherein the event response message is in response to the event message and contains a command to the online virtual game or online virtual social environment; and
relaying the event response message to the virtual game or virtual social environment for subsequent action therein.

11. The method of claim 10, wherein the event message is asynchronous.

12. The method of claim 10, wherein the communication device is a wireless mobile device or a landline device.

13. The method of claim 10, wherein at least a portion of the event message includes promotional offerings for the offline first user.

14. The method of claim 10, wherein at least a portion of the event message is relayed as an audible message to the offline first user.

15. The method of claim 10, the method steps further comprising:
relaying at least a portion of the event message to the communication devices of a plurality of offline user's; and
accepting an event response message from at least one of the plurality of offline users.

16. The method of claim 10, the method steps further comprising:
providing an Interactive Voice Response (IVR) device for accepting a spoken event response message from the offline first user.

17. The method of claim 10, the method steps further comprising:
providing an Interactive Voice Response (IVR) device for accepting a spoken event response message from the offline first user, wherein the event message contains interaction instructions intended for at least one offline second user; and
relaying at least a portion of the spoken event response message to the offline second user.

18. The method of claim 10, the method steps further comprising:
providing an Interactive Voice Response (IVR) device for accepting a spoken event response message from the offline first user, and wherein the event message contains interaction instructions intended for at least one offline second user; and
relaying at least a portion of the spoken event response message to the offline second user, wherein the portion of the spoken event message is relayed as an SMS, MMS, text, or email message to the offline second user.
